(19) United States
(12) Patent Application Publication
(10) Pub. No.: US 2015/0268112 A1
(43) Pub. Date: Sep. 24, 2015

(54) PHYSICAL QUANTITY SENSOR, ALTIMETER, ELECTRONIC APPARATUS, AND MOVING OBJECT

(71) Applicant: Seiko Epson Corporation, Tokyo (JP)

(72) Inventor: Aritsugu YAJIMA, Matsumoto (JP)

(21) Appl. No.: 14/659,916

(22) Filed: Mar. 17, 2015

(30) Foreign Application Priority Data
Mar. 18, 2014 (JP) 2014-054932

(51) Int. Cl. G01L 9/00

(52) U.S. Cl. CPC G01L 9/0052

(57) ABSTRACT

A physical quantity sensor includes: a diaphragm that can deflect and deform; a peripheral wall portion that is disposed around the diaphragm and has a thickness increasing in a direction away from the diaphragm; a deflection amount sensor that detects a deflection amount of the diaphragm; and a temperature sensor that is disposed in the peripheral wall portion.

### BACKGROUND

1. Technical Field

The present invention relates to a physical quantity sensor, an altimeter, an electronic apparatus, and a moving object.

2. Related Art

In the related art, a configuration including a diaphragm that deflects and deforms under pressure, a pressure detecting bridge circuit that includes four piezoresistive elements disposed in the diaphragm, and a temperature sensing bridge circuit that includes four piezoresistive elements disposed around the diaphragm has been known as a pressure sensor (e.g., refer to JP-A-2007-271379). According to such a pressure sensor, an output from the pressure detecting bridge circuit can be corrected in response to an output from the temperature sensing bridge circuit, so that the accuracy for detecting pressure is improved.

However, in the pressure sensor disclosed in JP-A-2007-271379, the piezoresistive elements included in the pressure detecting bridge circuit cannot be disposed in proximity of the piezoresistive elements included in the temperature sensing bridge circuit. In addition, since the piezoresistive elements included in the temperature sensing bridge circuit are disposed at a portion that is located around the diaphragm and has a thickness much thicker than that of the diaphragm, the heat from the outside is less likely to be conducted to the piezoresistive elements, compared to the piezoresistive elements included in the pressure detecting bridge circuit. Therefore, it is impossible in the temperature sensing bridge circuit to accurately sense the temperature of the piezoresistive elements included in the pressure detecting bridge circuit.

Hence, it is impossible in the pressure sensor disclosed in JP-A-2007-271379 to make a highly accurate correction on the output from the pressure detecting bridge circuit in response to the output from the temperature sensing bridge circuit, which gives rise to a problem that excellent accuracy for detecting pressure cannot be provided.

### SUMMARY

An advantage of some aspects of the invention is to provide a physical quantity sensor having excellent detection accuracy, and an altimeter, an electronic apparatus, and a moving object each including the physical quantity sensor and with high reliability.

The invention can be implemented as the following application examples.

### Application Example 1

A physical quantity sensor according to this application example includes: a diaphragm that can deflect and deform; a peripheral wall portion that is disposed around the diaphragm and has a thickness increasing in a direction away from the diaphragm; a deflection amount detecting element that is disposed in the diaphragm and detects a deflection amount of the diaphragm; and a temperature sensing element that is disposed in the peripheral wall portion.

With this configuration, a spaced apart distance between the temperature sensing element and the deflection amount detecting element can be shortened while reducing the transfer of stress occurring due to the deformation of the diaphragm to the temperature sensing element. Therefore, the physical quantity sensor having excellent detection accuracy is obtained.

### Application Example 2

In the physical quantity sensor of the application example, it is preferable that the thickness of the peripheral wall portion continuously increases in the direction away from the diaphragm.

With this configuration, stress concentration can be reduced when the diaphragm is deflected and deformed. That is, the stress can be effectively dispersed.

### Application Example 3

In the physical quantity sensor of the application example, it is preferable that the temperature sensing element is disposed along the perimeter of the diaphragm.

With this configuration, the spaced apart distance between the temperature sensing element and the deflection amount detecting element can be further shortened. Moreover, the downsizing of the physical quantity sensor can be achieved.

### Application Example 4

In the physical quantity sensor of the application example, it is preferable that the diaphragm has a rectangular shape in a plan view, and that the temperature sensing element is disposed on an extended line of a diagonal of the diaphragm in the plan view.

Since the place has high rigidity and is less deflectable compared to other portions, the temperature sensing element is less deformable, and thus the temperature sensing accuracy of the temperature sensing element is improved.

### Application Example 5

In the physical quantity sensor of the application example, it is preferable that the temperature sensing element includes a bent portion along the perimeter of the diaphragm.

With this configuration, since the temperature sensing element can be disposed along the perimeter of the diaphragm having a rectangular shape, the spaced apart distance between the temperature sensing element and the deflection amount detecting element can be further shortened. Moreover, the downsizing of the physical quantity sensor can be achieved.

### Application Example 6

In the physical quantity sensor of the application example, it is preferable that a plurality of the temperature sensing elements are disposed.

With this configuration, temperature sensing accuracy is improved.

### Application Example 7

In the physical quantity sensor of the application example, it is preferable that the diaphragm and the temperature sensing element, and a pressure reference chamber overlap each other in a plan view.

With this configuration, since the deflection amount detecting element and the temperature sensing element can be disposed in the pressure reference chamber, the deflection amount detecting element can be put in almost the same environment as in the temperature sensing element. Therefore, the temperature sensing accuracy of the temperature sensing element is improved.

### Application Example 8

In the physical quantity sensor of the application example, it is preferable that in a plan view, the diaphragm and a pressure reference chamber overlap each other, while the temperature sensing element and the pressure reference chamber are shifted from each other.

With this configuration, since the temperature sensing element can be provided at a position with higher rigidity, the temperature sensing element is less deformable, and thus the temperature sensing accuracy of the temperature sensing element is improved.

### Application Example 9

In the physical quantity sensor of the application example, it is preferable that the deflection amount detecting element is a piezoresistive element.

With this configuration, the deflection amount detecting element is easily configured.

### Application Example 10

In the physical quantity sensor of the application example, it is preferable that the temperature sensing element is a piezoresistive element.

With this configuration, the temperature sensing element is easily configured.

### Application Example 11

In the physical quantity sensor of the application example, it is preferable that the physical quantity sensor is a pressure sensor that detects pressure.

With this configuration, it is possible to detect the pressure received by the diaphragm.

### Application Example 12

An altimeter according to this application example includes the physical quantity sensor of the application example described above.

With this configuration, the altimeter with high reliability is obtained.

### Application Example 13

An electronic apparatus according to this application example includes the physical quantity sensor of the application example described above.

With this configuration, the electronic apparatus with high reliability is obtained.

### Application Example 14

A moving object according to this application example includes the physical quantity sensor of the application example described above.

With this configuration, the moving object with high reliability is obtained.

### BRIEF DESCRIPTION OF THE DRAWINGS

The invention will be described with reference to the accompanying drawings, wherein like numbers reference like elements.

FIG. 1 is a cross-sectional view showing a first embodiment of a physical quantity sensor according to the invention.

FIG. 2 is a plan view showing a deflection amount sensor and a temperature sensor that are included in the physical quantity sensor shown in FIG. 1.

FIG. 3 is a diagram for explaining a circuit including the deflection amount sensor shown in FIG. 2.

FIG. 4 is a cross-sectional view for explaining a method for manufacturing the physical quantity sensor shown in FIG. 1.

FIG. 5 is a cross-sectional view for explaining the method for manufacturing the physical quantity sensor shown in FIG. 1.

FIG. 6 is a cross-sectional view for explaining the method for manufacturing the physical quantity sensor shown in FIG. 1.

FIG. 7 is a cross-sectional view for explaining the method for manufacturing the physical quantity sensor shown in FIG. 1.

FIG. 8 is a cross-sectional view for explaining the method for manufacturing the physical quantity sensor shown in FIG. 1.

FIG. 9 is a cross-sectional view for explaining the method for manufacturing the physical quantity sensor shown in FIG. 1.

FIG. 10 is a cross-sectional view for explaining the method for manufacturing the physical quantity sensor shown in FIG. 1.

FIG. 11 is a cross-sectional view for explaining the method for manufacturing the physical quantity sensor shown in FIG. 1.

FIG. 12 is a plan view showing a second embodiment of a physical quantity sensor according to the invention.

FIG. 13 is a diagram for explaining a circuit including a temperature sensor shown in FIG. 12.

FIG. 14 is a cross-sectional view showing a third embodiment of a physical quantity sensor according to the invention.

FIG. 15 is a cross-sectional view showing a fourth embodiment of a physical quantity sensor according to the invention.

FIG. 16 is a perspective view showing an example of an altimeter according to the invention.

FIG. 17 is an elevation view showing an example of an electronic apparatus according to the invention.

FIG. 18 is a perspective view showing an example of a moving object according to the invention.

### DESCRIPTION OF EXEMPLARY EMBODIMENTS

Hereinafter, a physical quantity sensor, an altimeter, an electronic apparatus, and a moving object according to the invention will be described in detail based on embodiments shown in the accompanying drawings.

### 1. Physical Quantity Sensor

### First Embodiment

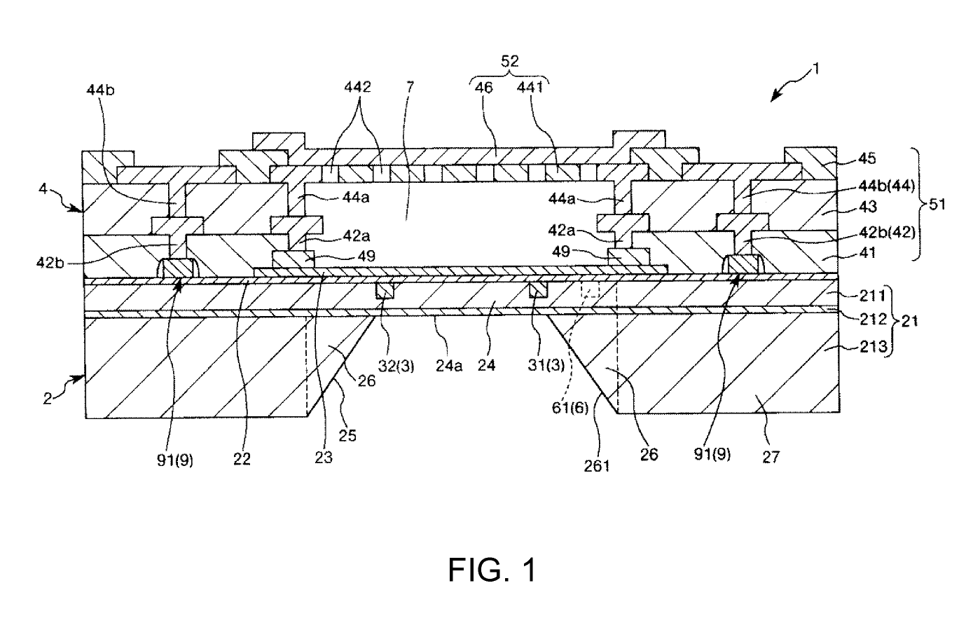

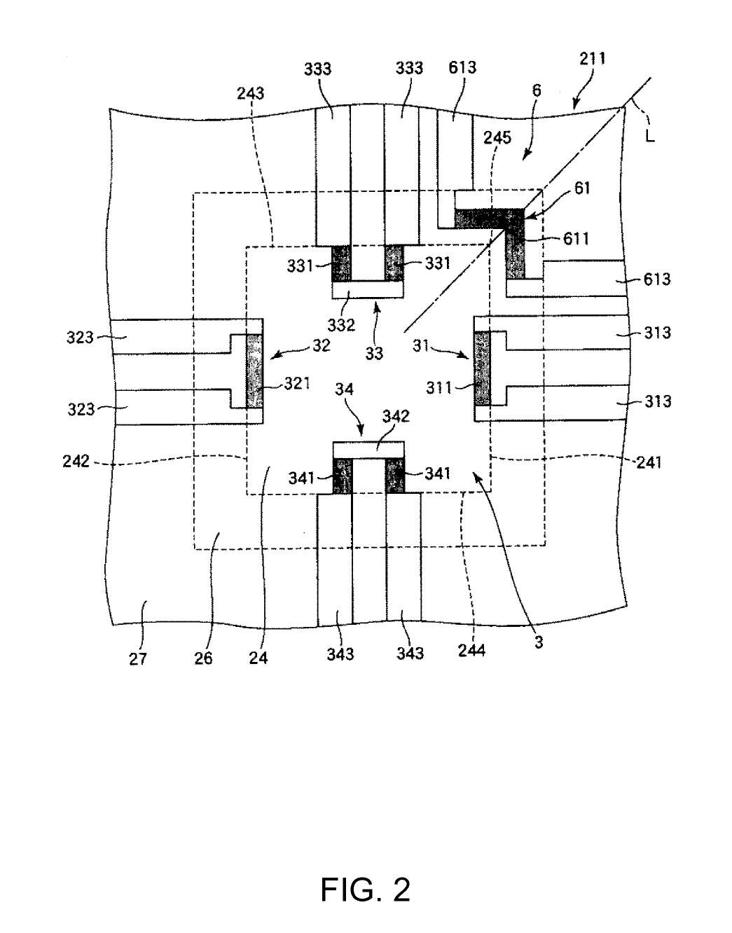

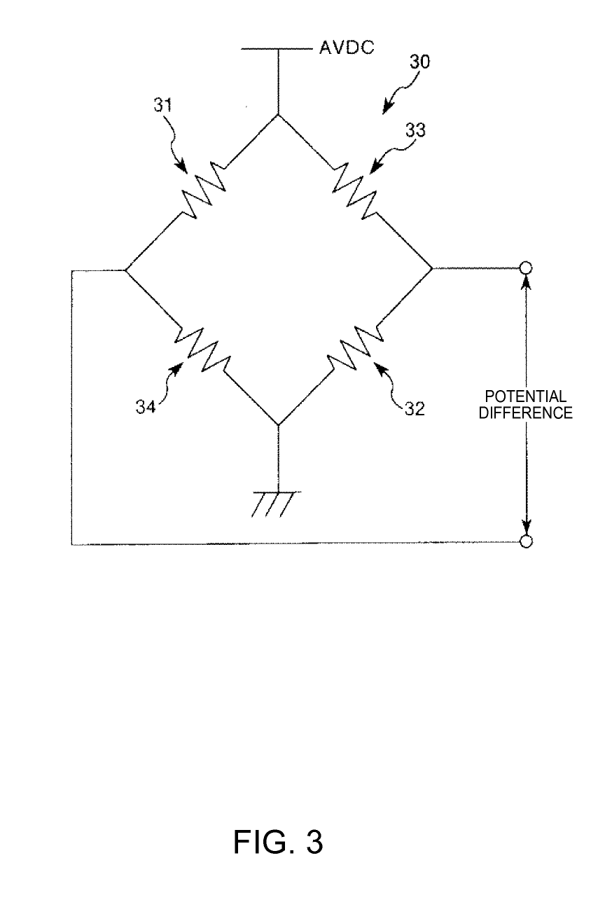

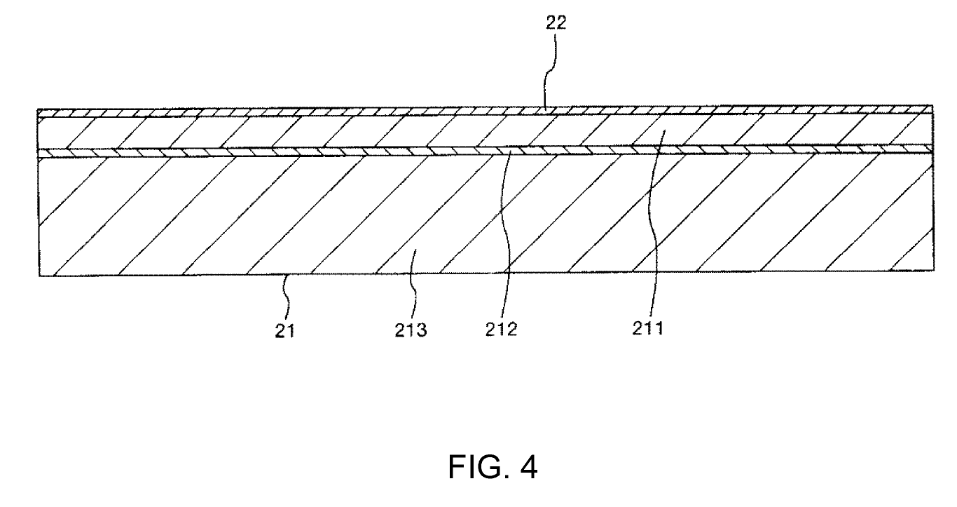

FIG. 1 is a cross-sectional view showing a first embodiment of a physical quantity sensor according to the invention. FIG. 2 is a plan view showing a deflection amount sensor and a temperature sensor that are included in the physical quantity sensor shown in FIG. 1. FIG. 3 is a diagram for explaining a circuit including the deflection amount sensor shown in FIG. 2. FIGS. 4 to 11 are cross-sectional views for explaining a method for manufacturing the physical quantity sensor shown in FIG. 1. In the following description, the upper side in FIG. 1 is defined as “up”, and the lower side is defined as “down”.

The physical quantity sensor 1 is a pressure sensor that can detect pressure. With the use of the physical quantity sensor 1 as a pressure sensor, the physical quantity sensor 1 can be mounted on various electronic apparatuses for purposes of, for example, measuring altitude.

As shown in FIG. 1, the physical quantity sensor 1 includes a substrate 2, the deflection amount sensor (pressure detecting sensor) 3, the temperature sensor 6, an element peripheral structure 4, a cavity portion 7, and semiconductor circuits 9. Hereinafter, these parts will be sequentially described.

### Substrate

The substrate 2 has a plate shape, and is configured by stacking, on a semiconductor substrate 21 composed of an SOI substrate (substrate having a first Si layer 211, an SiO₂ layer 212, and a second Si layer 213 stacked in this order), a first insulating film 22 composed of a silicon oxide film (SiO₂ film) and a second insulating film 23 composed of a silicon nitride film (SiN film) in this order. However, the semiconductor substrate 21 is not limited to an SOI substrate, and, for example, a silicon substrate can be used. Moreover, the materials of the first insulating film 22 and the second insulating film 23 are not particularly limited as long as the films can protect the semiconductor substrate 21 at the time of manufacture and insulate the semiconductor substrate 21, the deflection amount sensor 3, and the temperature sensor 6 from one another. Moreover, the plan-view shape of the substrate 2 is not particularly limited, and can be, for example, a rectangle such as a substantially square shape or a substantially oblong shape, or a circle. In the embodiment, the substrate 2 has a substantially square shape.

The semiconductor substrate 21 is provided with a diaphragm 24 that is thinner than the surrounding portion of the diaphragm and deflected and deformed under pressure. The diaphragm 24 is formed by providing a bottomed recess 25 in a lower surface (the second Si layer 213) of the semiconductor substrate 21. A lower surface (bottom surface of the recess 25) of the diaphragm 24 is a pressure receiving surface 24a. The plan-view shape of the diaphragm 24 is not particularly limited, and can be, for example, a rectangle such as a substantially square shape or a substantially oblong shape, or a circle. In the embodiment, the diaphragm 24 has a substantially square shape. The width of the diaphragm 24 is not particularly limited, but can be set within a range of, for example, from 400 μm to 600 μm. The thickness of the diaphragm 24 is not particularly limited, but, for example, the thickness preferably falls within a range of from 10 to 50 μm and more preferably falls within a range of from 15 μm to 25 μm. Due to this, the diaphragm 24 can be sufficiently softened and sufficiently deflected and deformed.

The semiconductor substrate 21 is disposed along the perimeter of the diaphragm 24. The semiconductor substrate 21 includes a frame-shaped peripheral wall portion 26 having a thickness that increases along a direction away from the diaphragm 24, and a frame-shaped thick portion 27 that is disposed along the perimeter of the peripheral wall portion 26 and has a thickness thicker than that of the diaphragm 24.

A lower surface (i.e., the inner surface of the recess 25) 261 of the peripheral wall portion 26 is an inclined surface that is inclined with respect to the thickness direction of the diaphragm 24. Therefore, the peripheral wall portion 26 has a tapered shape in which the thickness thereof progressively increases (continuously increases) from the diaphragm 24 side toward the thick portion 27 side (i.e., in the direction away from the diaphragm 24). By forming the peripheral wall portion 26 in a tapered shape as described above, stress concentration on the peripheral wall portion 26 can be reduced, and thus the peripheral wall portion 26 can be much less deflectable. Moreover, for example, since the inner surface of the recess 25 naturally becomes an inclined surface when the recess 25 is formed by wet etching, there is also an advantage that the peripheral wall portion 26 can be easily formed.

The semiconductor circuits (circuits) 9 are fabricated on and above the semiconductor substrate 21. The semiconductor circuits 9 include circuit elements such as active elements including MOS transistors 91 formed as necessary, capacitors, inductors, resistors, diodes, and wires. By fabricating the semiconductor circuits 9 on the substrate 2, the downsizing of the physical quantity sensor 1 can be achieved, compared to the case where the semiconductor circuits 9 are provided separately from the substrate 2. In FIG. 1, only the MOS transistors 91 are illustrated for convenience of description.

### Deflection Amount Sensor

As shown in FIG. 2, the deflection amount sensor 3 includes four piezoresistive elements (deflection amount detecting elements) 31, 32, 33, and 34 disposed in the diaphragm 24. Among the four piezoresistive elements, the piezoresistive elements 31 and 32 are disposed corresponding to one pair of facing sides 241 and 242 of the diaphragm 24 having a quadrilateral shape in a plan view, while the piezoresistive elements 33 and 34 are disposed corresponding to the other pair of facing sides 243 and 244 of the diaphragm 24 having a quadrilateral shape in the plan view.

The piezoresistive element 31 includes a piezoresistive portion 311 disposed at the outer edge (in the vicinity of the side 241) of the diaphragm 24. The piezoresistive portion 311 has a longitudinal shape extending along a direction parallel to the side 241. Wires 313 are connected to both ends of the piezoresistive portion 311.

Similarly, the piezoresistive element 32 includes a piezoresistive portion 321 disposed at the outer edge (in the vicinity of the side 242) of the diaphragm 24. The piezoresistive portion 321 has a longitudinal shape extending along a direction parallel to the side 242. Wires 323 are connected to both ends of the piezoresistive portion 321.

On the other hand, the piezoresistive element 33 includes a pair of piezoresistive portions 331 disposed at the outer edge (in the vicinity of the side 243) of the diaphragm 24, and a connecting portion 332 connecting the pair of piezoresistive portions 331 to each other. The pair of piezoresistive portions 331 are parallel to each other and each have a longitudinal shape extending along a direction (the same direction as the piezoresistive portions 311 and 321) vertical to the side 243. One ends of the pair of piezoresistive portions 331 are connected to each other via the connecting portion 332. Wires 333 are connected to the other ends of the pair of piezoresistive portions 331.

Similarly, the piezoresistive element 34 includes a pair of piezoresistive portions 341 disposed at the outer edge (in the vicinity of the side 244) of the diaphragm 24, and a connecting portion 342 connecting the pair of piezoresistive portions 341 to each other. The pair of piezoresistive portions 341 are parallel to each other and each have a longitudinal shape extending along a direction (the same direction as the piezoresistive portions 311 and 321) vertical to the side 244. One ends of the pair of piezoresistive portions 341 are connected to each other via the connecting portion 342. Wires 343 are connected to the other ends of the pair of piezoresistive portions 341.

The piezoresistive portions 311, 321, 331, and 341 are each configured by, for example, doping (diffusing or implanting) an impurity such as phosphorus or boron into the first Si layer 211 of the semiconductor substrate 21. The wires 313, 323, 333, and 343 and the connecting portions 332 and 342 are each configured by, for example, doping (diffusing or implanting) an impurity such as phosphorus or boron into the first Si layer 211 at a higher concentration than that in the piezoresistive portions 311, 321, 331, and 341.

In addition, however, the piezoresistive portions 311, 321, 331, and 341 may be configured by, for example, forming a polycrystalline silicon film on the diaphragm 24 by a sputtering method, a CVD method, or the like, patterning the polycrystalline silicon film by etching, and doping (diffusing or implanting) an impurity such as phosphorus or boron into the patterned polycrystalline silicon film. The same applies to the wires 313, 323, 333, and 343 and the connecting portions 332 and 342.

The piezoresistive elements 31, 32, 33, and 34 are configured such that the resistance values in a natural state are equal to each other. The piezoresistive elements 31, 32, 33, and 34 are electrically connected to each other via the wires 313, 323, 333, and 343 or the like to constitute a bridge circuit 30 (Wheatstone bridge circuit) as shown in FIG. 3. A driver circuit (not shown) that supplies a drive voltage AVDC is connected to the bridge circuit 30. The bridge circuit 30 outputs a signal (voltage) in response to the resistance value of the piezoresistive elements 31, 32, 33, and 34.

Even when the diaphragm 24 that is extremely thin is used, the deflection amount sensor 3 does not suffer from a problem of reduced Q value caused by vibration leakage to the diaphragm 24 as in the case where a vibrating element such as a resonator is used as a sensor element. Moreover, the piezoresistive elements 31, 32, 33, and 34 are configured by doping an impurity such as phosphorus or boron into the first Si layer 211, so that the low profile (thinning) of the physical quantity sensor 1 can be achieved, compared to the case where, for example, the piezoresistive elements 31, 32, 33, and 34 are provided by placing the piezoresistive elements on the upper surface of the diaphragm 24.

### Temperature Sensor

As shown in FIG. 2, the temperature sensor 6 includes a piezoresistive element (temperature sensing element) 61. The piezoresistive element 61 includes a piezoresistive portion 611. Wires 613 are connected to both ends of the piezoresistive portion 611. The piezoresistive portion 611 is disposed in the peripheral wall portion 26. Moreover, the piezoresistive portion 611 is disposed along the perimeter of the diaphragm 24. Due to this, it is possible to prevent the piezoresistive portion 611 from excessively extending outward, and accordingly, the downsizing of the physical quantity sensor 1 can be achieved.

Especially in the embodiment, the piezoresistive portion 611 is disposed in the vicinity of a corner portion 245 (i.e., on an extended line L of a diagonal of the diaphragm 24) of the diaphragm in the plan view, and bends substantially at a right angle in the middle to extend along the sides 241 and 243 (the perimeter of the diaphragm 24) connecting to the corner portion 245. That is, it can be said that the piezoresistive portion 611 includes a first portion extending along the side 241 and a second portion extending from one end of the first portion and extending along the side 243. The piezoresistive portion 611 is disposed by bending in the vicinity of the corner portion 245 as described above, so that the piezoresistive portion 611 can be disposed to be longer without sacrificing the space for disposing the deflection amount sensor 3 (or while keeping the space small). That is, the temperature sensor 6 can be disposed by making an effective use of the remaining space after disposing the deflection amount sensor 3. Therefore, the temperature sensor 6 having higher accuracy can be provided without impairing the detection sensitivity of the deflection amount sensor 3.

Since the piezoresistive element 61 has the property of changing its resistance value depending on temperature, it is possible based on the change in the resistance value of the piezoresistive element 61 to sense the temperature of the deflection amount sensor 3 located in the vicinity of the piezoresistive element 61.

Especially, since the piezoresistive element 61 is provided in the peripheral wall portion 26 in the physical quantity sensor 1, the following advantageous effects can be provided.

First, the peripheral wall portion 26 is thicker than the diaphragm 24 and much less deflectable than the diaphragm 24. By disposing the piezoresistive element 61 in the peripheral wall portion 26 that is much less deflectable than the diaphragm 24 as described above, the change in resistance value due to the deflection of the piezoresistive element 61 can be reduced, and thus the temperature of the deflection amount sensor 3 can be accurately sensed by the temperature sensor 6. Moreover, since the peripheral wall portion 26 is disposed around the diaphragm 24, the piezoresistive element 61 can be disposed in the vicinity of the deflection amount sensor 3. Also in this regard, the temperature of the deflection amount sensor 3 can be accurately sensed by the temperature sensor 6.

Second, since the heat capacity of the peripheral wall portion 26 is reduced by forming the peripheral wall portion 26 in a tapered shape (in other words, by making the peripheral wall portion 26 thinner than the thick portion 27), the heat capacity of the peripheral wall portion 26 can be close to the heat capacity of the diaphragm 24. Therefore, when, for example, the temperatures of the piezoresistive elements 31, 32, 33, and 34 and the piezoresistive element 61 are elevated due to the heat from the lower surface side of the substrate 2, it is possible to reduce a difference between the temperature change of the piezoresistive element 61 and the temperature change of the piezoresistive elements 31, 32, 33, and 34. Hence, also in this regard, the temperature of the deflection amount sensor 3 can be accurately sensed by the temperature sensor 6.

The piezoresistive portion 611 is configured by, for example, doping (diffusing or implanting) an impurity such as phosphorus or boron into the first Si layer 211. The wire 613 is configured by, for example, doping (diffusing or implanting) an impurity such as phosphorus or boron into the first Si layer 211 at a higher concentration than that in the piezoresistive portion 611. The piezoresistive element 61 is configured by doping an impurity such as phosphorus or boron into the first Si layer 211, so that the temperature sensor 6 can be easily provided. In addition, the low profile (thinning) of the physical quantity sensor 1 can be achieved compared to the case where, for example, a separate member such as a thermocouple is provided by placing the separate member on the upper surface of the diaphragm 24.

Other than that, however, the piezoresistive portion 611 may be configured by, for example, forming a polycrystalline silicon film on the peripheral wall portion 26 by a sputtering method, a CVD method, or the like, patterning the polycrystalline silicon film by etching, and doping (diffusing or implanting) an impurity such as phosphorus or boron into the patterned polycrystalline silicon film. The same applies to the wires 313, 323, 333, and 343 and the connecting portions 332 and 342.

### Element Peripheral Structure 4

The element peripheral structure 4 is formed so as to define the cavity portion 7. The element peripheral structure 4 includes an annular wall portion 51 and a covering portion 52. The wall portion 51 is formed on the substrate 2 so as to surround the deflection amount sensor 3 and the temperature sensor 6. The covering portion 52 closes an opening of the cavity portion 7 surrounded by the inner wall of the wall portion 51.

The element peripheral structure 4 includes: an inter-layer insulating film 41; a wiring layer 42 formed on the inter-layer insulating film 41; an inter-layer insulating film 43 formed on the wiring layer 42 and the inter-layer insulating film 41; a wiring layer 44 formed on the inter-layer insulating film 43; a surface protective film 45 formed on the wiring layer 44 and the inter-layer insulating film 43; and a sealing layer 46. The wiring layer 44 includes a covering layer 441 including a plurality of fine pores 442 communicating between the interior and exterior of the cavity portion 7. The sealing layer 46 disposed on the covering layer 441 seals the fine pores 442. In the element peripheral structure 4, the inter-layer insulating film 41, the wiring layer 42, the inter-layer insulating film 43, the wiring layer 44 (only a portion except for the covering layer 441), and the surface protective film 45 constitute the wall portion 51 described above, while the covering layer 441 and the sealing layer 46 constitute the covering portion 52 described above.

The wiring layers 42 and 44 include wiring layers 42a and 44a formed so as to surround the cavity portion 7, and wiring layers 42b and 44b constituting wires of the semiconductor circuits 9. Hence, the semiconductor circuits 9 are drawn to the upper surface of the physical quantity sensor 1 through the wiring layers 42b and 44b. Moreover, a film 49 formed of, for example, a polycrystalline silicon film is provided between the wiring layer 42a and the second insulating film 23.

The inter-layer insulating films 41 and 43 are not particularly limited, but, for example, an insulating film such as a silicon oxide film (SiO₂ film) can be used. The wiring layers 42 and 44 are not particularly limited, but, for example, a metal film such as an aluminum film can be used. The sealing layer 46 is not particularly limited, but a metal film such as of Al, Cu, W, Ti, or TiN can be used. The surface protective film 45 is not particularly limited, but a film having resistance for protecting the element from moisture, dust, flaw, or the like, such as a silicon oxide film, a silicon nitride film, a polyimide film, or an epoxy resin film, can be used.

### Cavity Portion

The cavity portion 7 defined by the substrate 2 and the element peripheral structure 4 is a hermetically sealed space, and functions as a pressure reference chamber serving to provide a reference value of pressure that the physical quantity sensor 1 detects. The cavity portion 7 is disposed so as to overlap the diaphragm 24. The diaphragm 24 constitutes a portion of a wall portion that defines the cavity portion 7. The interior state of the cavity portion 7 is not particularly limited but preferably a vacuum state (e.g., 10 Pa or less). Due to this, the physical quantity sensor 1 can be used as an “absolute pressure sensor” that detects pressure with the vacuum state as a reference. Therefore, the convenience of the physical quantity sensor 1 is improved. However, the interior state of the cavity portion 7 may not be the vacuum state, and may be, for example, an atmospheric pressure state, a reduced-pressure state where the air pressure is lower than the atmospheric pressure, or a pressurized state where the air pressure is higher than the atmospheric pressure. Moreover, an inert gas such as nitrogen gas or noble gas may be sealed in the cavity portion 7.

In the embodiment, the piezoresistive element 61 included in the temperature sensor 6 is located inside the cavity portion 7 in the plan view. That is, the diaphragm 24 and the piezoresistive element 61, and the cavity portion 7 are located to overlap each other. Due to this, since the piezoresistive elements 31, 32, 33, and 34 included in the deflection amount sensor 3 and the piezoresistive element 61 included in the temperature sensor 6 are located inside the cavity portion 7 in the plan view, thermal environments (more specifically, e.g., the amounts of heat conducted from the upper surface side of the physical quantity sensor 1) of the piezoresistive elements 31, 32, 33, and 34 and the piezoresistive element 61 can be made substantially the same as each other. Therefore, the temperature of the deflection amount sensor 3 can be accurately sensed by the temperature sensor 6.

The configuration of the physical quantity sensor 1 has been briefly described above.

In the physical quantity sensor 1, the diaphragm 24 is deflected and deformed in response to the pressure received by the pressure receiving surface 24a of the diaphragm 24, whereby the piezoresistive elements 31, 32, 33, and 34 strain and the resistance value of the piezoresistive elements 31, 32, 33, and 34 changes in response to the amount of deflection. With the change in resistance value, the output of the bridge circuit 30 changes. In this case, the piezoresistive elements 31, 32, 33, and 34 each have the property of changing its resistance value due to its own temperature (ambient temperature) (temperature dependence of resistance value) other than its own deflection. Therefore, the change in the output of the bridge circuit 30 is caused by the deflection of the piezoresistive elements 31, 32, 33, and 34 and the temperature of the piezoresistive elements 31, 32, 33, and 34, so that the magnitude of the pressure (absolute pressure) received by the pressure receiving surface 24a cannot be accurately obtained from the output (signal). In the physical quantity sensor 1, therefore, the temperature of the deflection amount sensor 3 is sensed by the temperature sensor 6, the signal obtained from the bridge circuit 30 is corrected (the amount of change caused by the temperature of the piezoresistive elements 31, 32, 33, and 34 is removed) based on the sensed temperature, and the magnitude of the pressure (absolute pressure) received by the pressure receiving surface 24a is obtained based on the corrected signal. Due to this, the pressure received by the pressure receiving surface 24a can be accurately obtained.

In the physical quantity sensor 1 described above, since the cavity portion 7 and the semiconductor circuits 9 are provided on the same surface side of the semiconductor substrate 21, the element peripheral structure 4 forming the cavity portion 7 does not protrude from the side of the semiconductor substrate 21 opposite to the semiconductor circuits 9, and thus the low profile can be achieved. Besides, the element peripheral structure 4 is formed in the same deposition as at least one of the inter-layer insulating film 41 or 43 and the wiring layer 42 or 44. Due to this, the element peripheral structure 4 can be formed together with the semiconductor circuits 9 by utilizing a CMOS process (especially a step of forming the inter-layer insulating films 41 and 43 or the wiring layers 42 and 44). Therefore, the manufacturing steps of the physical quantity sensor 1 are simplified, and as a result, the low cost of the physical quantity sensor 1 can be achieved. Moreover, even when the cavity portion 7 is sealed as in the embodiment, the cavity portion 7 can be sealed using a deposition method, which eliminates the need to seal a cavity by bonding substrates together as in the related art. Also in this regard, the manufacturing steps of the physical quantity sensor 1 are simplified, and as a result, the low cost of the physical quantity sensor 1 can be achieved.

Moreover, as described above, the deflection amount sensor 3 includes the piezoresistive elements 31, 32, 33, and 34; the temperature sensor 6 includes the piezoresistive element 61; and the deflection amount sensor 3, the temperature sensor 6, and the semiconductor circuits 9 are located on the same surface side of the semiconductor substrate 21. Therefore, the deflection amount sensor 3 and the temperature sensor 6 can be formed together with the semiconductor circuits 9 by utilizing a CMOS process. Therefore, also in this regard, the manufacturing steps of the physical quantity sensor 1 can be further simplified.

Moreover, since the deflection amount sensor 3 and the temperature sensor 6 are disposed on the element peripheral structure 4 side of the diaphragm 24, the deflection amount sensor 3 and the temperature sensor 6 can be accommodated in the cavity portion 7. Therefore, it is possible to prevent the degradation of the deflection amount sensor 3 and the temperature sensor 6 or reduce the characteristic lowering of the deflection amount sensor 3 and the temperature sensor 6.

Next, a method for manufacturing the physical quantity sensor 1 will be briefly described.

FIGS. 4 to 11 show the manufacturing steps of the physical quantity sensor 1 shown in FIG. 1. The manufacturing steps will be described below based on the drawings.

### Deflection Amount Sensor and Temperature Sensor Forming Step

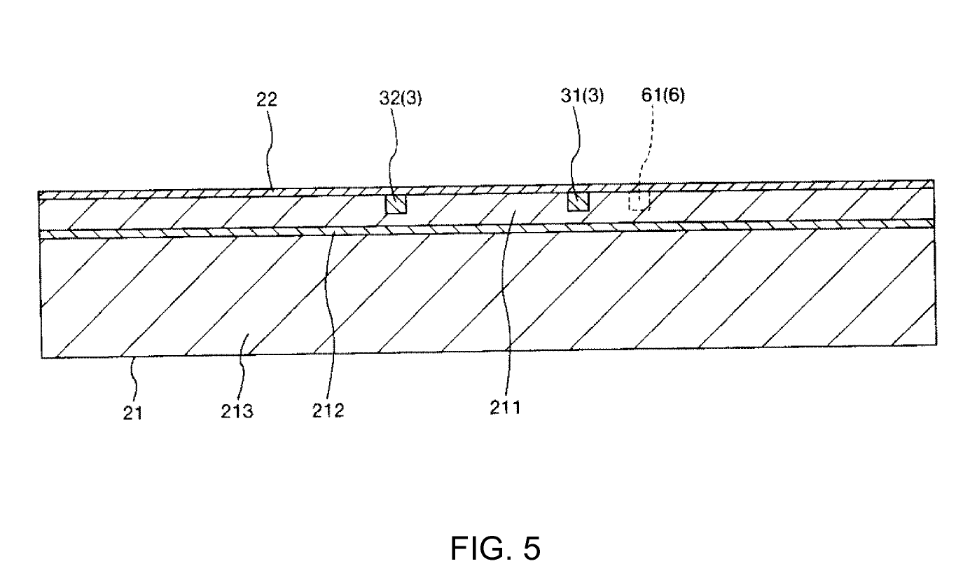

First, as shown in FIG. 4, the semiconductor substrate 21 formed of an SOI substrate (substrate having the first Si layer 211, the SiO₂ layer 212, and the second Si layer 213 stacked in this order) is prepared, and a surface of the semiconductor substrate 21 is thermally oxidized to form the first insulating film (silicon oxide film) 22. Next, as shown in FIG. 5, an impurity such as phosphorus or boron is doped (ion implanted) into the first Si layer 211 via a mask (not shown) to thereby form the deflection amount sensor 3 (the piezoresistive elements 31 to 34) and the temperature sensor 6 (the piezoresistive element 61), or the source and drain electrodes of the MOS transistors 91. In the ion implantation, ion implantation conditions or the like are adjusted such that the doping amount of the impurity into the piezoresistive portions 311, 321, 331, 341, and 611 is larger than that of the impurity into the connecting portions 332 and 342 and the wires 313, 323, 333, 343, and 613.

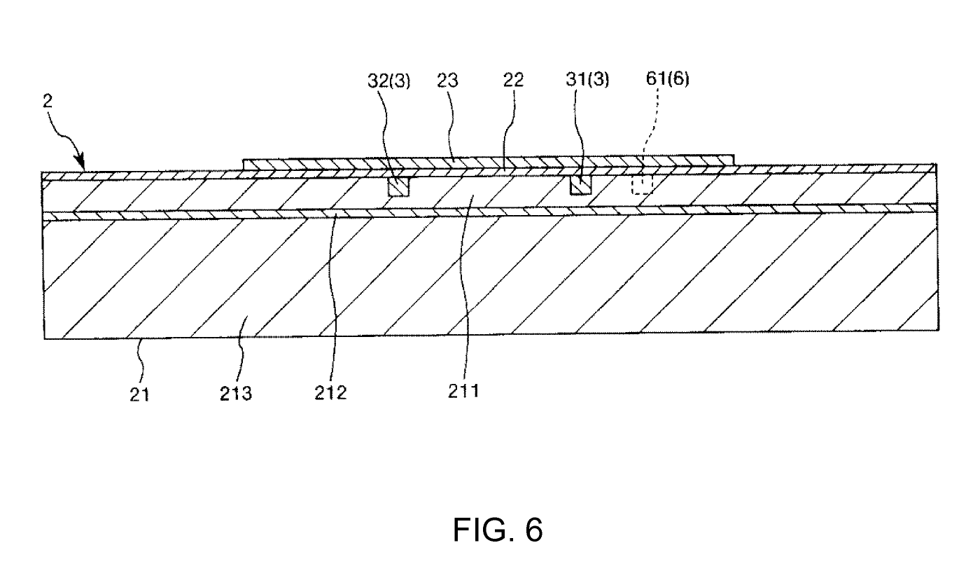

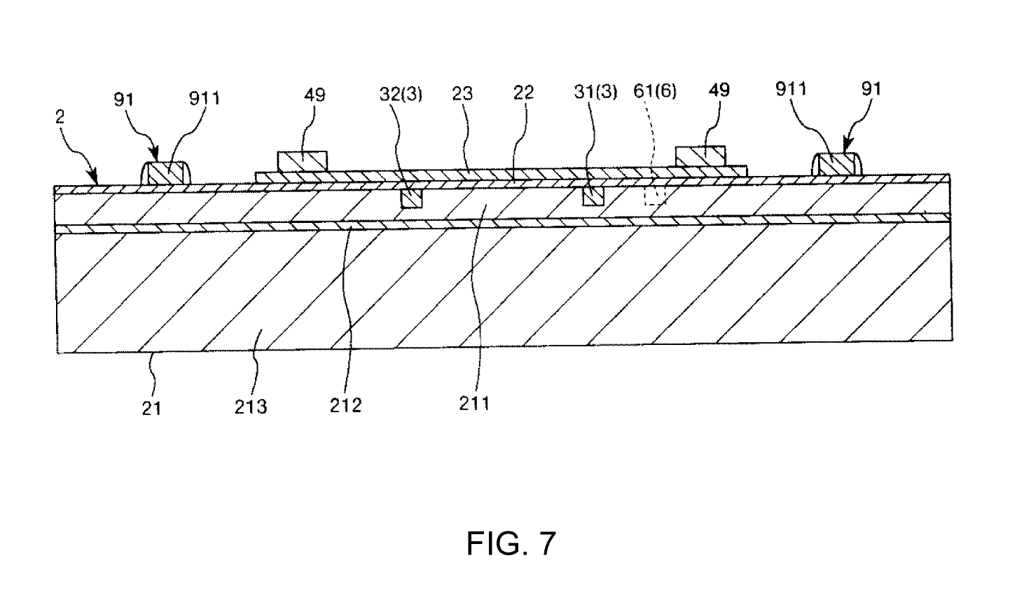

Next, as shown in FIG. 6, the second insulating film (silicon nitride film) 23 is formed on the first insulating film 22 by a sputtering method, a CVD method, or the like. The second insulating film 23 has resistance to etching that is implemented in a cavity portion forming step performed later, and functions as a so-called etching stop layer. Next, as shown in FIG. 7, a polycrystalline silicon film (or amorphous silicon film) is formed on an upper surface of the substrate 2 by a sputtering method, a CVD method, or the like, and the polycrystalline silicon film is patterned by etching to thereby form gate electrodes 911 of the MOS transistors 91 and the film 49.

### Inter-Layer Insulating Film and Wiring Layer Forming Step

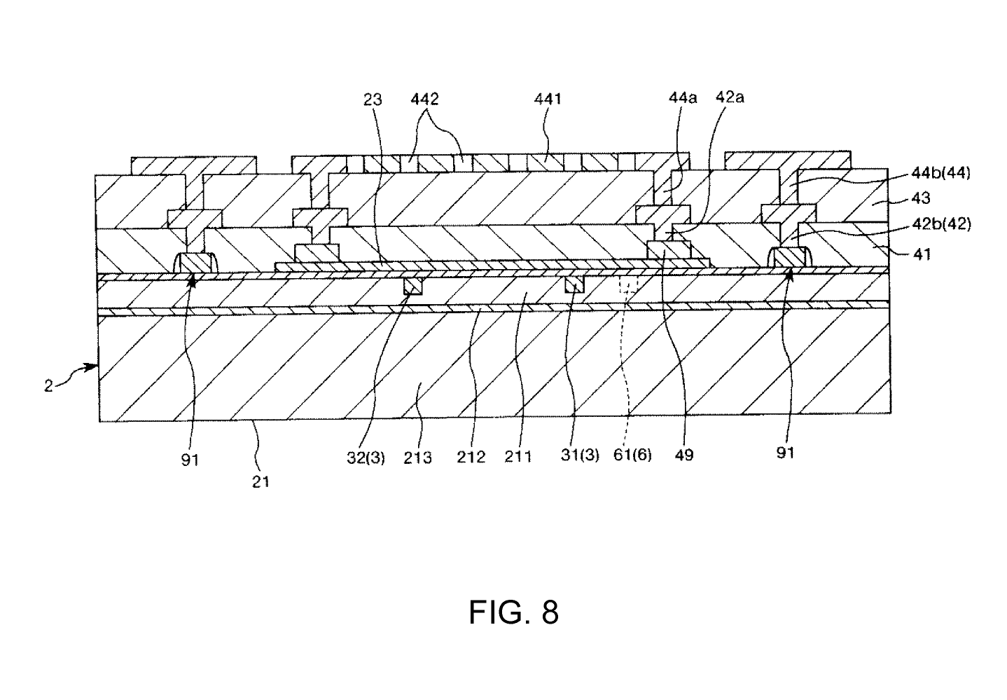

As shown in FIG. 8, the inter-layer insulating films 41 and 43 and the wiring layers 42 and 44 are formed on the upper surface of the substrate 2. Due to this, the deflection amount sensor 3, the temperature sensor 6, the MOS transistors 91, and the like are brought into a state of being covered with the inter-layer insulating films 41 and 43 and the wiring layers 42 and 44. The formation of the inter-layer insulating films 41 and 43 is performed by forming a silicon oxide film by a sputtering method, a CVD method, or the like and patterning the silicon oxide film by etching. The thickness of each of the inter-layer insulating films 41 and 43 is not particularly limited but set to, for example, about from 1500 nm to 5000 nm. The formation of the wiring layers 42 and 44 is performed by forming, on the inter-layer insulating films 41 and 43, a layer formed of, for example, aluminum by a sputtering method, a CVD method, or the like and then processing the layer by patterning. In this case, the thickness of each of the wiring layers 42 and 44 is not particularly limited but set to, for example, about from 300 nm to 900 nm.

The wiring layers 42a and 44a each have an annular shape so as to surround the deflection amount sensor 3 and the temperature sensor 6 in the plan view. Moreover, the wiring layers 42b and 44b are electrically connected to wires (e.g., wires constituting portions of the semiconductor circuits 9) formed on and above the semiconductor substrate 21.

The stacked structure of the inter-layer insulating films 41 and 43 and the wiring layers 42 and 44 is formed by a common CMOS process, and the number of stacked layers is appropriately set as necessary. That is, more wiring layers may be stacked as necessary via an inter-layer insulating film.

### Cavity Portion Forming Step

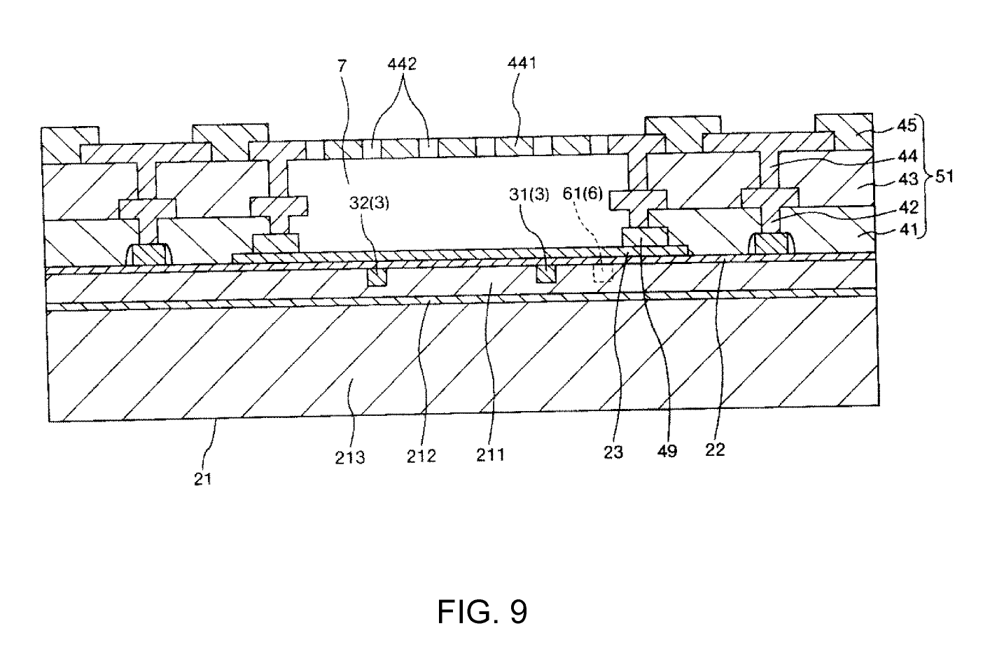

As shown in FIG. 9, the surface protective film 45 is formed by a sputtering method, a CVD method, or the like, and then, the cavity portion 7 is formed by etching. The surface protective film 45 is composed of a plurality of film layers including one or more kinds of materials, and is formed so as not to seal the fine pores 442 of the covering layer 441. As to the constituent material of the surface protective film 45, the surface protective film 45 is formed of a material having resistance for protecting the element from moisture, dust, flaw, or the like, such as a silicon oxide film, a silicon nitride film, a polyimide film, or an epoxy resin film. The thickness of the surface protective film 45 is not particularly limited but set to, for example, about from 500 nm to 2000 nm.

The formation of the cavity portion 7 is performed by removing portions of the inter-layer insulating films 41 and 43 by etching through the plurality of fine pores 442 formed in the covering layer 441. In this case, when wet etching is used for the etching, an etchant such as hydrofluoric acid or buffered hydrofluoric acid is supplied through the plurality of fine pores 442; and when dry etching is used, an etching gas such as hydrofluoric acid gas is supplied through the plurality of fine pores 442.

### Sealing Step

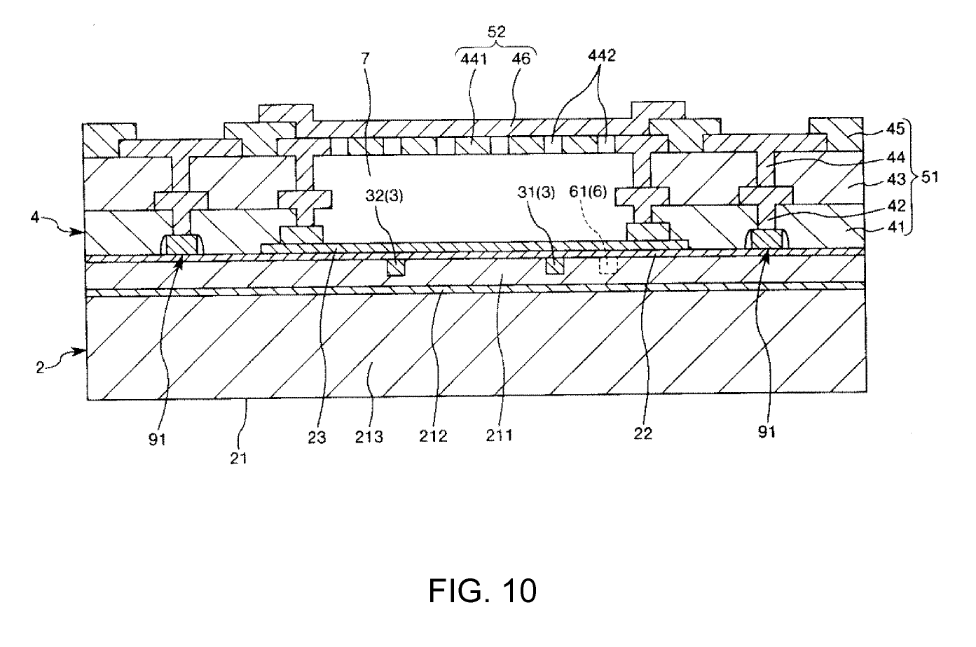

Next, as shown in FIG. 10, the sealing layer 46 formed of a metal film or the like such as of Al, Cu, W, Ti, or TiN is formed on the covering layer 441 by a sputtering method, a CVD method, or the like to seal the fine pores 442. Due to this, the cavity portion 7 is sealed by the sealing layer 46, and the covering portion 52 is formed. The thickness of the sealing layer 46 is not particularly limited but set to, for example, about from 1000 nm to 5000 nm.

### Diaphragm Forming Step

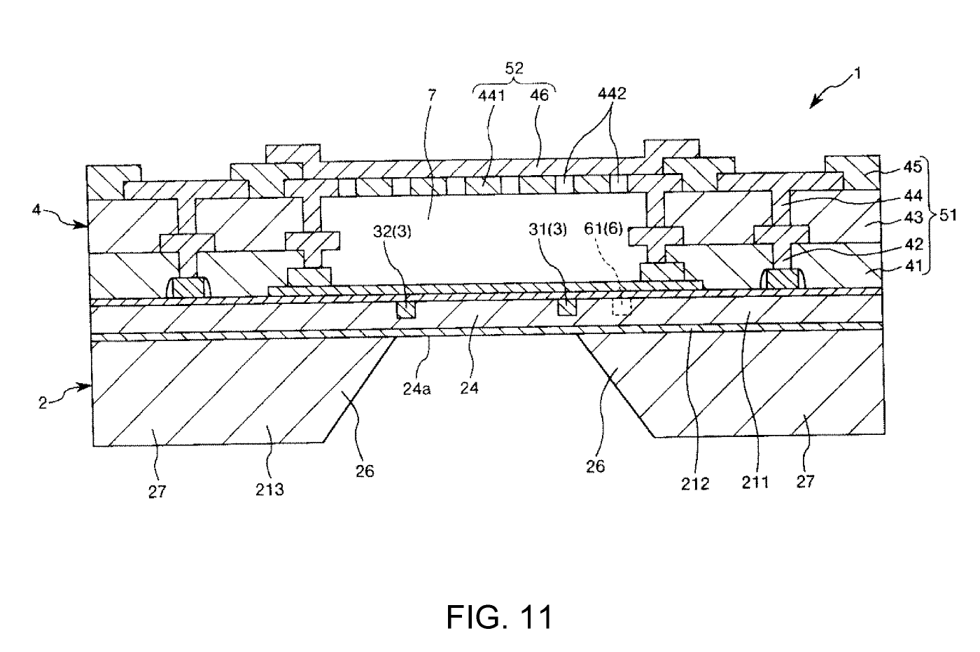

Finally, as shown in FIG. 11, a portion of the lower surface (the second Si layer 213) of the semiconductor substrate 21 is removed by wet etching. Due to this, the diaphragm 24, the peripheral wall portion 26, and the thick portion 27 are formed. In wet etching, the SiO₂ layer 212 functions as an etching stop layer. Therefore, the thickness of the diaphragm 24 can be controlled with high accuracy. Due to this, the physical quantity sensor 1 is obtained.

Through the steps described above, the physical quantity sensor 1 can be manufactured. The circuit elements, such as active elements other than the MOS transistors, capacitors, inductors, resistors, diodes, and wires, included in the semiconductor circuits can be fabricated in the course of the appropriate step (e.g., the deflection amount sensor and temperature sensor forming step, the inter-layer insulating film and wiring layer forming step, or the sealing step).

### Second Embodiment

Next, a second embodiment of a physical quantity sensor according to the invention will be described.

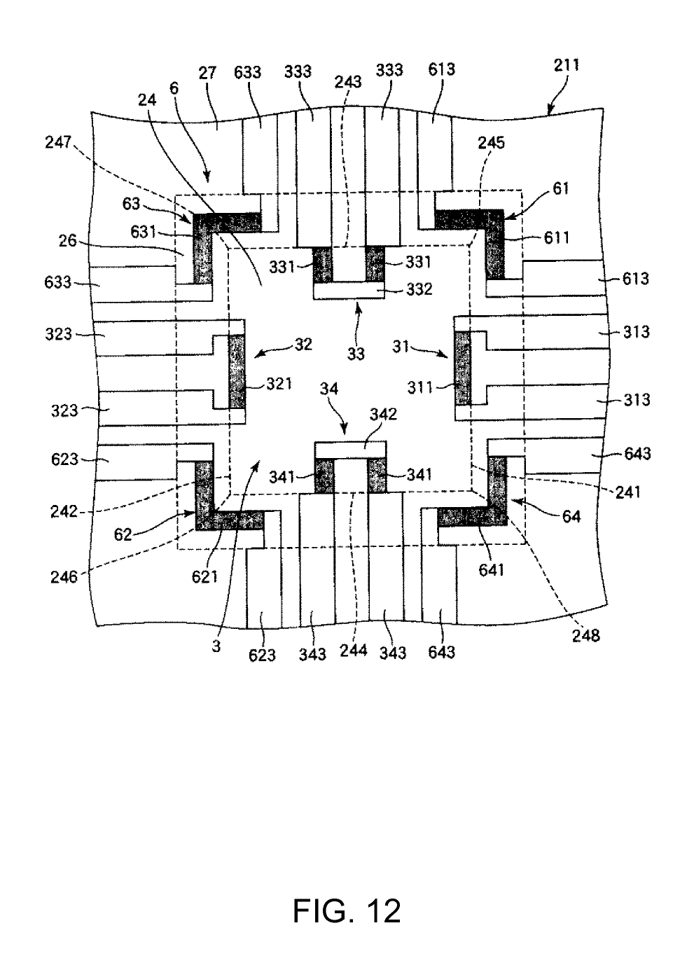

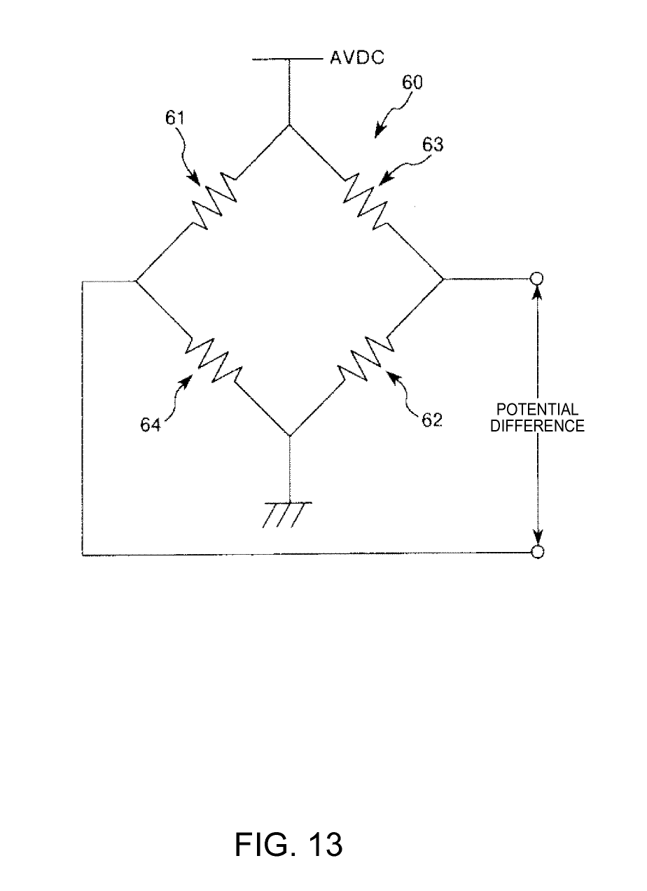

FIG. 12 is a plan view showing the second embodiment of the physical quantity sensor according to the invention. FIG. 13 is a diagram for explaining a circuit including a temperature sensor shown in FIG. 12.

Hereinafter, the second embodiment of the physical quantity sensor according to the invention will be described, in which differences from the embodiment described above are mainly described and the description of similar matters is omitted.

The second embodiment is similar to the first embodiment described above, except that the configuration of the temperature sensor is different.

As shown in FIG. 12, a temperature sensor 6 of the embodiment includes four piezoresistive elements (temperature sensing elements) 61, 62, 63, and 64. The piezoresistive elements 61, 62, 63, and 64 include piezoresistive portions 611, 621, 631, and 641. Wires 613, 623, 633, and 643 are connected to both ends of the piezoresistive portions 611, 621, 631, and 641, respectively.

The piezoresistive portions 611, 621, 631, and 641 are located outside the diaphragm 24 in the plan view, and disposed in the peripheral wall portion 26. Moreover, the piezoresistive portions 611, 621, 631, and 641 are disposed along the perimeter of the diaphragm 24 in the plan view. Specifically, the piezoresistive portion 611 is disposed in the vicinity of a corner portion 245 of the diaphragm, and bends substantially at a right angle in the middle to extend along sides 241 and 243 connecting to the corner portion 245. The piezoresistive portion 621 is disposed in the vicinity of a corner portion 246 of the diaphragm, and bends substantially at a right angle in the middle to extend along sides 242 and 244 connecting to the corner portion 246. The piezoresistive portion 631 is disposed in the vicinity of a corner portion 247 of the diaphragm, and bends substantially at a right angle in the middle to extend along the sides 242 and 243 connecting to the corner portion 247. The piezoresistive portion 641 is disposed in the vicinity of a corner portion 248 of the diaphragm, and bends substantially at a right angle in the middle to extend along the sides 241 and 244 connecting to the corner portion 248.

The piezoresistive portions 611, 621, 631, and 641 are each configured by, for example, doping (diffusing or implanting) an impurity such as phosphorus or boron into the first Si layer 211. The wires 613, 623, 633, and 643 are each configured by, for example, doping (diffusing or implanting) an impurity such as phosphorus or boron into the first Si layer 211 at a higher concentration than that in the piezoresistive portions 611, 621, 631, and 641.

The piezoresistive elements 61, 62, 63, and 64 are configured such that the resistance values in a natural state are equal to each other. The piezoresistive elements 61, 62, 63, and 64 are electrically connected to each other via the wires 613, 623, 633, and 643 or the like to constitute a bridge circuit 60 (Wheatstone bridge circuit) as shown in FIG. 13. A driver circuit (not shown) that supplies the drive voltage AVDC is connected to the bridge circuit 60. The bridge circuit 60 outputs a signal (voltage) in response to the resistance value of the piezoresistive elements 61, 62, 63, and 64. According to the temperature sensor 6, the temperature can be sensed more accurately.

Advantageous effects similar to those of the first embodiment described above can be provided also by the second embodiment.

The number of piezoresistive elements included in the temperature sensor 6 is not limited to four and may be, for example, two or three. Moreover, the temperature sensor 6 may not constitute the bridge circuit 60.

### Third Embodiment

Next, a third embodiment of a physical quantity sensor according to the invention will be described.

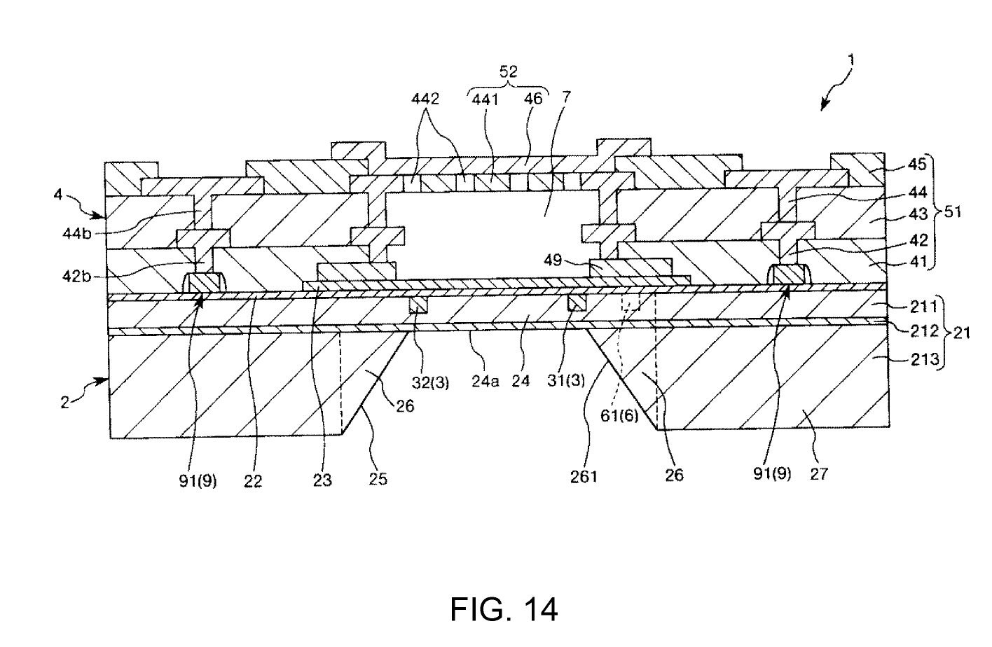

FIG. 14 is a cross-sectional view showing the third embodiment of the physical quantity sensor according to the invention.

Hereinafter, the third embodiment of the physical quantity sensor according to the invention will be described, in which differences from the embodiments described above are mainly described and the description of similar matters is omitted.

The third embodiment is similar to the first embodiment described above, except that the arrangement of the temperature sensor is different.

As shown in FIG. 14, in the physical quantity sensor of the embodiment, the piezoresistive element 61 (the piezoresistive portion 611) included in the temperature sensor 6 is located outside the cavity portion 7 in the plan view. That is, in the plan view, the diaphragm 24 and the cavity portion 7 overlap each other, while the piezoresistive element 61 and the cavity portion 7 are shifted from each other. The piezoresistive element 61 is disposed at a position overlapping the wall portion 51 of the element peripheral structure 4. In other words, it can be said that the inner perimeter of the wall portion 51 is located on the diaphragm side of the piezoresistive element 61 in the plan view. By adopting the configuration described above, the peripheral wall portion 26 is reinforced by the wall portion 51, and therefore, the peripheral wall portion 26 is much less deflectable. Hence, it is possible to more effectively reduce a change in resistance value due to the deformation of the piezoresistive element 61, and thus the temperature of the deflection amount sensor 3 can be accurately sensed by the temperature sensor 6.

Advantageous effects similar to those of the first embodiment described above can be provided also by the third embodiment.

### Fourth Embodiment

Next, a fourth embodiment of a physical quantity sensor according to the invention will be described.

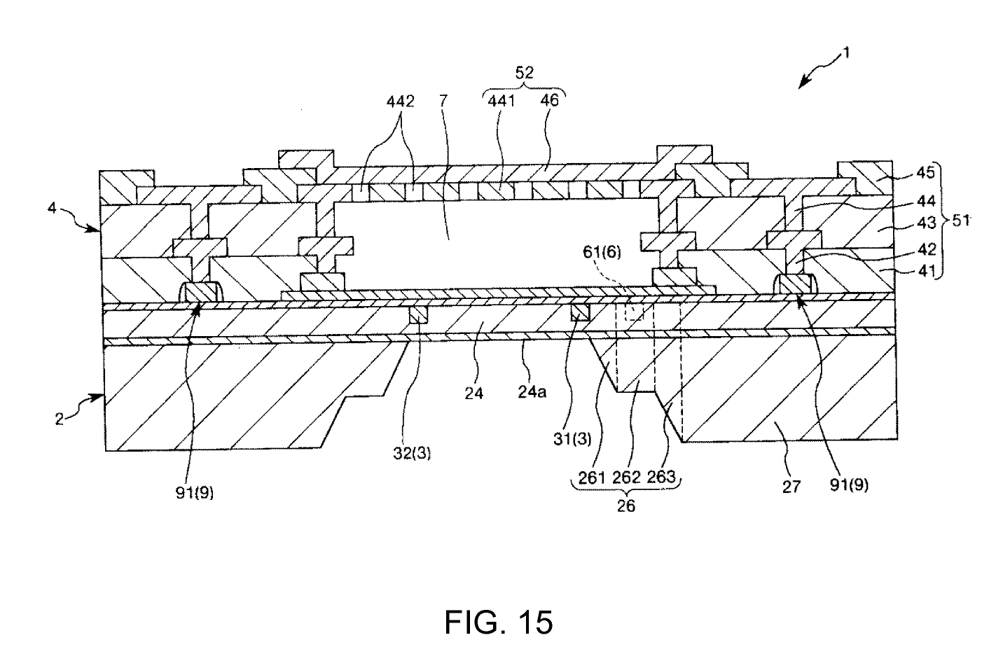

FIG. 15 is a cross-sectional view showing the fourth embodiment of the physical quantity sensor according to the invention.

Hereinafter, the fourth embodiment of the physical quantity sensor according to the invention will be described, in which differences from the embodiments described above are mainly described and the description of similar matters is omitted.

The fourth embodiment is similar to the first embodiment described above, except that the shape of the peripheral wall portion is different.

As shown in FIG. 15, in the physical quantity sensor 1 of the embodiment, the peripheral wall portion 26 includes a first tapered portion 261, a constant thickness portion 262, and a second tapered portion 263. The first tapered portion 261 is connected to the outer perimeter of the diaphragm 24 and has a thickness that progressively increases toward the thick portion 27. The constant thickness portion 262 is connected to the outer perimeter of the first tapered portion 261 and has a substantially constant thickness. The second tapered portion 263 is connected to the outer perimeter of the constant thickness portion 262 and has a thickness that progressively increases toward the thick portion 27. The piezoresistive element 61 (the piezoresistive portion 611) of the temperature sensor 6 is located so as to overlap the constant thickness portion 262 in the plan view. However, the position of the piezoresistive element 61 is not limited to that. For example, the piezoresistive element 61 may be located so as to overlap the first tapered portion 261 or may be located so as to overlap the second tapered portion 263.

Advantageous effects similar to those of the first embodiment described above can be provided also by the fourth embodiment.

### 2. Altimeter

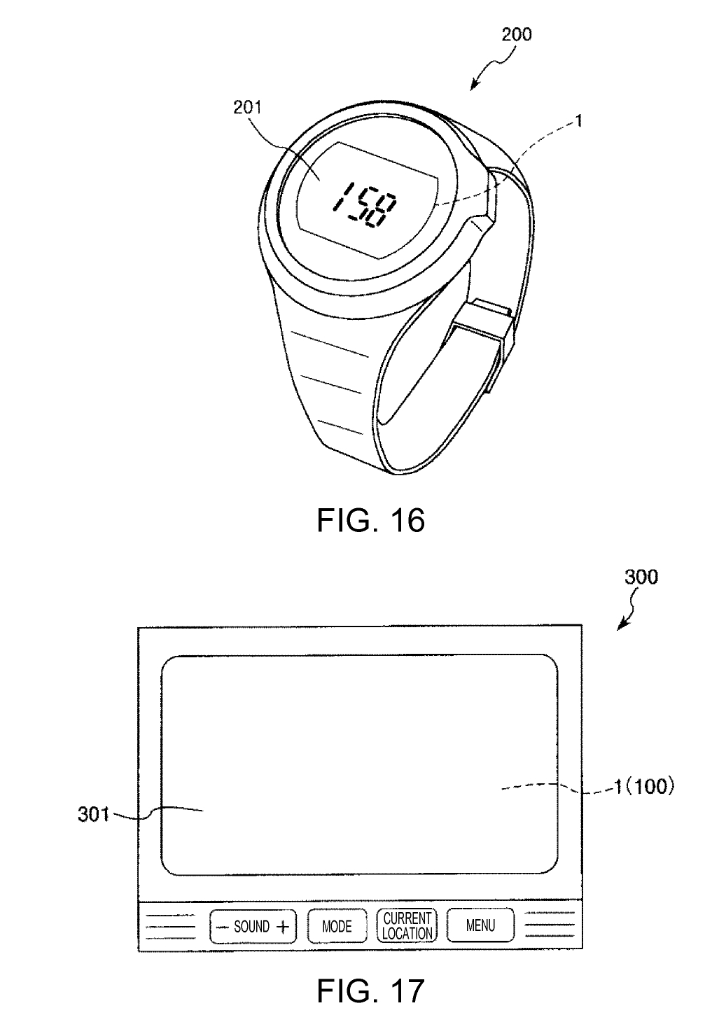

Next, an example of an altimeter including the physical quantity sensor according to the invention will be described. FIG. 16 is a perspective view showing the example of the altimeter according to the invention.

The altimeter 200 can be worn on the wrist like a wristwatch. The physical quantity sensor 1 is mounted in the altimeter 200, so that the altitude of a current location above sea level, the air pressure of a current location, and the like can be displayed on a display portion 201.

On the display portion 201, various information such as a current time, a user's heart rate, and weather can be displayed.

### 3. Electronic Apparatus

Next, a navigation system to which an electronic apparatus including the physical quantity sensor according to the invention is applied will be described. FIG. 17 is an elevation view showing an example of the electronic apparatus according to the invention.

The navigation system 300 includes map information (not shown), a position information acquiring unit that acquires position information from a global positioning system (GPS), a self-contained navigation unit using a gyro sensor, an acceleration sensor, and vehicle speed data, the physical quantity sensor 1, and a display portion 301 that displays predetermined position information or course information.

According to the navigation system, altitude information can be acquired in addition to acquired position information. For example, when a car runs on an elevated road indicated on the position information at substantially the same position as an open road, the navigation system cannot determine, in the absence of altitude information, whether the car runs on the open road or the elevated road, and therefore, the navigation system provides the user with information on the open road as preferential information. Therefore, in the navigation system 300 according to the embodiment, altitude information can be acquired by the physical quantity sensor 1, a change in altitude due to the car entering the elevated road from the open road is detected, and it is possible to provide the user with navigation information in a running state on the elevated road.

The display portion 301 is composed of, for example, a liquid crystal panel display or an organic electro-luminescence (EL) display, so that reductions in size and thickness are possible.

The electronic apparatus including the physical quantity sensor according to the invention is not limited to that described above, and can be applied to, for example, personal computers, mobile phones, medical apparatuses (e.g., electronic thermometers, sphygmomanometers, blood glucose meters, electrocardiogram measuring systems, ultrasonic diagnosis apparatuses, and electronic endoscopes), various kinds of measuring instrument, indicators (e.g., indicators used in vehicles, aircraft, and ships), and flight simulators.

### 4. Moving Object

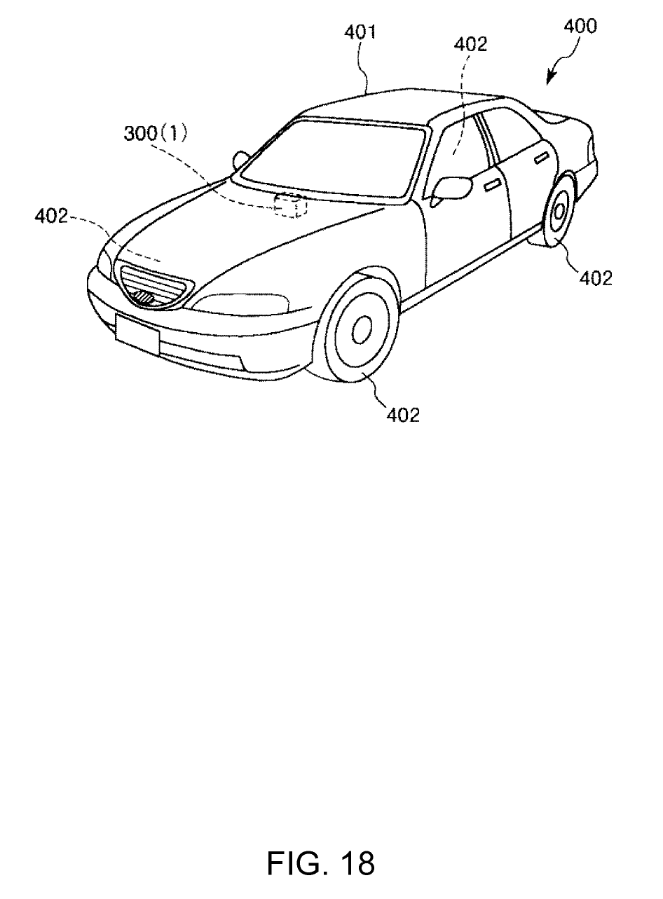

Next, a moving object including the physical quantity sensor according to the invention will be described. FIG. 18 is a perspective view showing an example of the moving object according to the invention.

As shown in FIG. 18, the moving object 400 includes a car body 401 and four wheels 402, and is configured to rotate the wheels 402 with a source of power (engine) (not shown) provided in the car body 401. Into the moving object 400, the navigation system 300 (the physical quantity sensor 1) is built.

The physical quantity sensor, the altimeter, the electronic apparatus, and the moving object according to the invention have been described above based on the embodiments shown in the drawings, but the invention is not limited to the embodiments. The configuration of each part can be replaced with any configuration having a similar function. Moreover, any other configurations or steps may be added to the embodiments.

Although an example of using a piezoresistive element as a deflection amount detecting element included in the deflection amount sensor has been described in the embodiments described above, the invention is not limited to the example. For example, a vibrating element such as other MEMS vibrators like a flap-type vibrator or an inter-digital electrode, or a quartz crystal vibrator can also be used.

Although the deflection amount sensor including four piezoresistive elements has been described in the embodiments described above, the invention is not limited to that. The number of piezoresistive elements may be from one to three, or five or more.

The entire disclosure of Japanese Patent Application No. 2014-054932, filed Mar. 18, 2014 is expressly incorporated by reference herein.

What is claimed is:

1. A physical quantity sensor comprising:
a diaphragm that can deflect and deform;
a peripheral wall portion that is disposed around the diaphragm and has a thickness increasing in a direction away from the diaphragm;
a deflection amount detecting element that is disposed in the diaphragm and detects a deflection amount of the diaphragm; and
a temperature sensing element that is disposed in the peripheral wall portion.

2. The physical quantity sensor according to claim 1, wherein the thickness of the peripheral wall portion continuously increases in the direction away from the diaphragm.

3. The physical quantity sensor according to claim 1, wherein the temperature sensing element is disposed along the perimeter of the diaphragm.

4. The physical quantity sensor according to claim 1, wherein
the diaphragm has a rectangular shape in a plan view, and
the temperature sensing element is disposed on an extended line of a diagonal of the diaphragm in the plan view.

5. The physical quantity sensor according to claim 4, wherein the temperature sensing element includes a bent portion along the perimeter of the diaphragm.

6. The physical quantity sensor according to claim 1, wherein a plurality of the temperature sensing elements are disposed.

7. The physical quantity sensor according to claim 1, wherein the diaphragm and the temperature sensing element, and a pressure reference chamber overlap each other in a plan view.

8. The physical quantity sensor according to claim 1, wherein in a plan view, the diaphragm and a pressure reference chamber overlap each other, while the temperature sensing element and the pressure reference chamber are shifted from each other.

9. The physical quantity sensor according to claim 1, wherein the deflection amount detecting element is a piezoresistive element.

10. The physical quantity sensor according to claim 1, wherein the temperature sensing element is a piezoresistive element.

11. The physical quantity sensor according to claim 1, which is a pressure sensor that detects pressure.

12. An altimeter comprising the physical quantity sensor according to claim 1.

13. An electronic apparatus comprising the physical quantity sensor according to claim 1.

14. A moving object comprising the physical quantity sensor according to claim 1.
